(19) United States
(12) Patent Application Publication
(10) Pub. No.: US 2017/0063636 A1
(43) Pub. Date: Mar. 2, 2017

(54) METHOD FOR AUTOMATED DETERMINATION OF OPTIMAL INTERCONNECTION TOPOLOGIES OF SYSTEMS INCLUDING SERVICE NODES, AND ASSOCIATED PROCESSING DEVICE

(71) Applicant: BULL SAS, Les Clayes-Sous-Bois (FR)

(72) Inventors: Pierre VIGNERAS, ANGERVILLIERS (FR); Kevin REMY, MEAUX (FR)

(21) Appl. No.: 15/255,325

(22) Filed: Sep. 2, 2016

(30) Foreign Application Priority Data
Sep. 2, 2015 (FR) 1558131

(51) Int. Cl. H04L 12/24; H04L 12/933

(52) U.S. Cl. CPC H04L 41/12; H04L 49/15

(57) ABSTRACT

A method allows the determination of an optimal interconnection topology of a system including service nodes which are interconnected using links, and some of which are routers with ports, and belonging to at least one level. This method includes a first step in which a structure is chosen for an optimal interconnection topology to be determined from among a set of structures each defined by at least one structural constraint, and at least one topology parameter is then chosen, and a second step in which one determines using a solver the optimal interconnection topology defined by at least each corresponding structural constraint and each chosen topology parameter and at least one chosen optimisation criterion.

### CROSS-REFERENCE TO RELATED APPLICATIONS

This application claims priority to French Patent Application No. 1558131; filed Sep. 2, 2015, the entire content of which is incorporated herein by reference in its entirety.

### FIELD

The invention relates to systems including service nodes which are interconnected via links and, more specifically, the determination of interconnection topologies of such systems.

### BACKGROUND

The term “service node” in this context is understood to mean an electronic device including resources which can be of any type if they provide at least one configurable service useful to the system to which they belong, or to an application operating in this system. Consequently, this may relate, for example, to a computation device including at least one processor, or an input/output device, or a router (or switch), or alternatively a data storage system.

Furthermore, the term “interconnection topology” is understood to mean the architecture (or the interconnection network) defining all the links (or interconnections) between all the service nodes of a system. This relates to a non-directional graph in which the peaks represent, for example, routers and the arcs represent the links (or wires). It will be observed that several topology structures exist, and in particular those known as “hierarchical structures”, ring structures (with direct topology), and networked structures. Of the hierarchical structures one may, for example, cite in particular those called Fat tree, Generalised Fat Tree (or GFT), Extended Generalised Fat Tree (or XGFT), and Parallel Generalised Fat Tree (or PGFT). Among the networked structures one may in particular cite the one called “HyperX”.

Bearing in mind the above two definitions, a system may, in particular, be a computer of the high-performance type (or supercomputer), or a data centre.

The determination (or dimensioning) of the interconnection topology of a system such as, for example, a supercomputer, is a complex task due to the large number of constraints which must be taken into account, and in particular performance level, cost, technical feasibility, logistical constraints (and in particular encumbrance) and thermal constraints.

Due to this complexity, determination (or dimensioning) of the interconnection topology of a system is frequently implemented manually after the structure of this interconnection topology has been chosen, leading to several disadvantages. Indeed, the determined interconnection topology is rarely optimal from all standpoints, or technically infeasible, and therefore many modifications must be made, frequently leading to substantial additional costs and/or possible delays of provision to the client and/or a possible reduction of the initially desired level of performance.

An information technology tool exists, of the “web” type, developed by the company Mellanox, intended to determine (or dimension) interconnection topologies. This tool is suitable for structures of the Fat Tree type, and enables the number of compute nodes to be chosen, together with the type of router to use on the first two levels of interconnection topology, and the blocking factor. The main disadvantage of this tool is that it only provides the number of routers and links required to establish the system, and therefore gives no information on the topological configuration (such as a formal description, for example), which is however essential for an assessment of the quality of the topology in terms of routing and quality/price ratio. Moreover, traditional or generally purpose computers or computer systems are not well suited for implementing or helping implement determination (or dimensioning) of the interconnection topology of a system.

### SUMMARY

An aspect of the invention is therefore, in particular, to improve the situation.

In particular, an embodiment proposes to this end a method intended to allow determination of an optimal interconnection topology of a system including service nodes which are interconnected using links, and some of which are routers with ports, and belonging to at least one level.

This method includes:

a first step in which a structure for an optimal interconnection topology is chosen, to be determined from among a set of structures each one of which is defined by at least one structural constraint, and at least one topology parameter is then chosen from among a maximum number of router ports, a number of levels of routers, a number of service nodes connected to a router belonging to the first level, a number of service nodes of a level i−1 connected to the same router of a level i, a number of routers of a level i connected to the same service node of a level i−1, a number of links (or connections) between a router of a level i and a service node of a level i−1, and

a second step in which a solver determines the optimal interconnection topology defined by at least one corresponding structural constraint, and each chosen topology parameter, and at least one chosen optimisation criterion.

By this means it is possible to determine the optimal interconnection topologies of different structures which are technically feasible, i.e. which match clients' requirements without requiring many modifications when they are installed.

The method according to one or more embodiments the invention can include other characteristics which can be considered separately or in combination and, in particular:

each optimisation criterion can be chosen from among (at least) the cost of the system, a level of performance, the extensibility of the system, the system's energy consumption, thermal constraints, and the system's encumbrance;

each structural constraint can be chosen from (at least) the following inequalities: pᵢ*mᵢ+pᵢ₊₁*wᵢ₊₁≦radixMax, pₕ*mₕ≦radixMax, and w₁*p₁+noeudsParFeuille≦radixMax, where mᵢ is the number of service nodes of a level i−1 connected to given router of a level i, wᵢ is the number of routers of a level i connected to given service node of a level i−1, pᵢ is the number of links (or connections) between a router of a level i and a service node of a level i−1, radixMax is the maximum number of ports of each router, h is the number of levels of routers, and noeudsParFeuille is the number of service nodes connected to a given router belonging to the first level;

in the second step the optimal interconnection topology can also be determined in terms of at least one chosen usage constraint;
each usage constraint can be chosen from (at least) a prohibition against connecting to a router belonging to a given level i more links (or connections) to the level above this given level than links (or connections) to the level below this given level, conservation of an input and output bandwidth of each router, non-conservation of an input and output bandwidth of each router, a minimum number of service nodes, and a maximum number of links (connections) between two routers;

the system can be chosen from among (at least) one supercomputer and one data centre.

An aspect of the invention also proposes a computer program product including a set of instructions which, when it is executed by processing means, is able to implement a method of the type presented above to determine an optimal interconnection topology of a system including service nodes which are interconnected using links, and some of which are routers with ports, and belonging to at least one level. The computer program product may be implemented in a non-transitory machine readable medium. The computer program product includes a set of instructions for implementing each step of the method.

Another aspect of The invention also proposes a processing device, intended to determine an optimal interconnection topology of a system including service nodes interconnected using links, some of which are routers with ports, and belonging to at least one level, and able to be fitted to an electronic device including computational resources and a man-machine interface.

This processing device includes:

a programming interface designed to enable the user to choose, via the man-machine interface, a structure for an optimal interconnection topology to be determined from among a set of structures each one of which is defined by a least one structural constraint, at least one topology parameter chosen from among a maximum number of router ports, a number of levels of routers, a number of service nodes connected to a router belonging to the first level, a number of service nodes of a level i−1 connected to a the same router of a level i, a number of routers of a level i connected to the same service node of a level i−1, a number of links (or connections) between a router of a level i and service node of a level i−1, and

resolution system configured to determine the optimal interconnection topology defined by at least each corresponding structural constraint, and each chosen topology parameter, and by at least one chosen optimisation criterion.

An aspect of the invention also proposes an electronic device including computational resources, a man-machine interface, and a processing device of the type presented above.

### BRIEF DESCRIPTION OF THE DRAWINGS

Other characteristics and benefits of the invention will be seen clearly on an examination of the detailed description below, and the appended illustrations, in which:

FIG. 1 illustrates diagrammatically and functionally a computer equipped with an example embodiment of a processing device according to an embodiment of the invention,

FIG. 2 illustrates an example of an algorithm implementing a method of determination according to an embodiment of the invention, and

FIG. 3 illustrates diagrammatically an example of an optimised interconnection topology, determined by a method of determination according to an embodiment of the invention with certain topology parameters.

### DETAILED DESCRIPTION

An aspect of the invention is to propose a method of determination, and an associated processing device DT, intended to allow the determination of an optimal interconnection technology of a system S comprising service nodes Nᵢⱼ.

In what follows it is considered, as a non-restrictive example, that system S is a high-performance computer (or supercomputer). But the invention is not restricted to this type of system. Indeed, it relates to all systems including service nodes which are interconnected using links, some of which are routers with ports, and belonging to at least one level, and in particular data centres.

As stated above, an aspect of the invention proposes a method intended to allow determination of an optimal interconnection technology of a system S (in this case a supercomputer) including service nodes Nᵢⱼ which are interconnected using links, and some of which are routers with ports, and belonging to at least one level.

This method includes first and second steps, referenced respectively 10 and 20 in the example algorithm of FIG. 2, which can be implemented by a processing device DT according to an aspect of the invention.

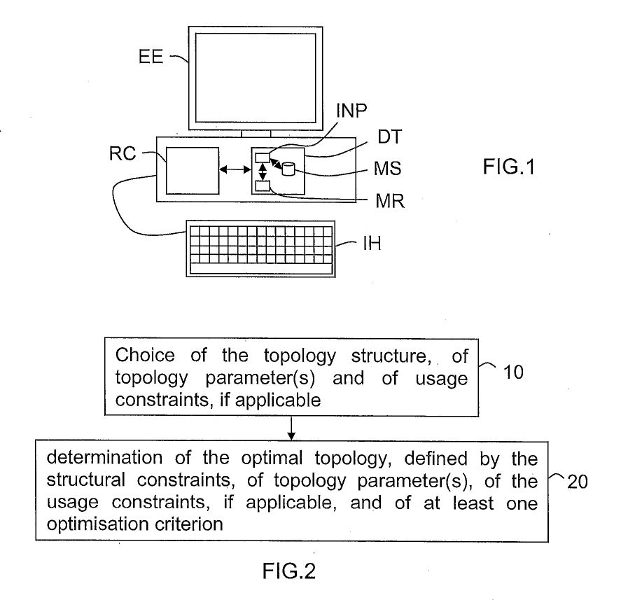

As illustrated in FIG. 1, a processing device DT, according to an embodiment of the invention, includes at least one programming interface INP and resolution system MR.

For example, the programming interface INP can be of the API type (“Application Programming Interface”). As a non-restrictive example, it can be created from a Python library, such as the library called Pyomo. It should be noted that Pyomo is a Python library which allows the generation, in a particular format (.nl) supported by many equation resolution programs, of systems of equations which have been declared and instantiated beforehand by means of an API.

In the non-restrictive example illustrated in FIG. 1, processing device DT is installed in an electronic device EE designed in the form of a computer, and therefore having, in particular, a man-machine interface IH (in this case a keyboard and a display screen) and computational resources RC. But this is not obligatory. Processing device DT could, indeed, be an electronic device with a man-machine interface IH and computational resources RC. It could thus be a laptop computer or an electronic tablet, for example. In addition, in a non-illustrated variant embodiment, processing device DT could be installed in an electronic device EE designed in a form other than a computer, and in particular in the form of a laptop computer or an electronic tablet. Consequently, processing device DT can be embodied either in the form of software modules, in which case this is a computer program including a set of instructions which, when it is executed by a processing device of the electronic circuit type (or hardware), is able to implement the method of determination, or in the form of a combination of software modules and electronic circuits.

It will be appreciated that the different steps of the method work in concert to determine the optimal interconnection topology of the system including service nodes. In particular, by virtue of performing the specific steps of the method described herein, it will be appreciated that the described method provides an interconnection topology of the system that is different from that that would be obtained using a conventional approach or a conventional approach that would have been implemented on a general purpose computer. It will also be appreciated that the processing device described herein is a special purpose computer as it is specifically constructed to perform the method described herein.

During first step 10 of the method according to an embodiment the invention, the human agent (a user of electronic device EE) starts by choosing, from among a set of structures each of which is defined by at least one structural constraint, and by the man-machine interface IH, a structure for an optimal interconnection topology which is determined for a system S. The set of structures is provided by programming interface INP of processing device DT. For example, this set may include at least one structure of the hierarchical type (such as, for example, Fat tree or Generalised Fat Tree (or GFT) or Extended Generalised Fat Tree (or XGFT) or alternatively Parallel Generalised Fat Tree (or PGFT)) and/or at least one ring structure and/or one networked structure (such as for example HyperX).

For example, each of the hierarchical structures may be defined by at least one structural constraint defined by at least two variables mᵢ and wᵢ, and sometimes also by a third variable pᵢ, in which index i indexes the level to which a router within the structure belongs. mᵢ is the number of service nodes Nᵢ₋₁ⱼ of a level i−1 connected to a given router Nᵢⱼ of a level i. wᵢ is the number of routers Nᵢⱼ of a level i connected to a given service node Nᵢ₋₁ⱼ of a level i−1. pᵢ is the number of links (or connections) between a router Nᵢⱼ of a level i and a service node Nᵢ₋₁ⱼ of a level i−1. These variables m, w and p are vectors of dimension h. With the choice made above for indexing, the value i=0 is attributed to the level containing service nodes N₀ⱼ which are connected to routers N₁ⱼ (called “leaves”) of the first level (i=1).

Thus a GFT (Generalised Fat Tree) can be defined by at least. one structural constraint defined by two variables m and w (vectors of dimension equal to one), and also by h, where ∀i∈[[1,h]], each router Nᵢⱼ of level i is connected to m service nodes Nᵢ₋₁ⱼ of lower level i−1, and each router Nᵢ₋₁ⱼ of level i−1 is connected to w routers Nᵢⱼ of upper level i. It can therefore be noted (h,m,w).

An XGFT (Extended Generalised Fat Tree) can be defined by at least one structural constraint defined by the two variables m and w (vectors of dimension equal to h), and by h, where ∀i∈[[1,h]], mᵢ>0 wᵢ>0. It can therefore be noted (h,[m₁, m₂, . . . , mₕ], [w₁, w₂, . . . ,wₕ]). In addition, it enables different links to be obtained (number of ascending/descending links) for the different levels i of the tree structure.

A PGFT (Parallel Generalised Fat Tree) is an XGFT to which third vector p has been added. It can therefore be noted (h,[m₁, m₂, . . . , mₕ], [w₁, w₂, . . . ,wₕ],[p₁, p₂, . . . ,pₕ]). It enables the notion to be introduced of redundancy of connections between service nodes of two adjacent levels.

First step 10 continues by choosing at least one topology parameter from among:

a maximum number of ports of routers Nᵢⱼ (with i≧1),

a number h of levels of routers Nᵢⱼ (with i≧1),

a number of service nodes N₀ⱼ connected to a router N₁ⱼ belonging to the first level (i=1),

a number of routers Nᵢ₋₁ⱼ of a level i−1 connected to given router Nᵢⱼ of a level i,

a number of routers Nᵢⱼof a level i connected to a given service node Nᵢ₋₁ⱼ of a level i−1, and

a number of links (connections) between a router Nᵢⱼ of a level i and a service node Nᵢ₋₁ⱼ of a level i−1.

It will be noted that the user of electronic device EE can choose, using the man-machine interface IH, each topology parameter from a list of topology parameters supplied by programming interface INP.

This list can, for example, be stored in a storage system MS of processing device DT. This storage system MS can, for example, take the form of a memory, possibly of the software type.

An aspect of the invention therefore proposes to define in an unambiguous manner the structure of each interconnection topology on the basis of one or more structural constraints (each defined by at least one variable), due to the regularity of the theoretical interconnection topologies. It will be noted that these structural constraints, and therefore the interconnection topology structures, can even be expressed in the form of mathematical equations, as indicated below.

As an example for PGFT structures, each structural constraint can be chosen from the following inequalities ∀i∈[1,h−1], where h is the number of levels of routers of the interconnection topology:

pᵢ*mᵢ+pᵢ₊₁*wᵢ₊₁≦radixMax (this structural constraint enables it to be specified that the number of links connected to a router does not exceed the number of ports available on this router),

pₕ*mₕ≦radixMax, and

w₁*p₁+noeudsParFeuille≦radixMax,

where radixMax is the maximum number of ports of each router Nᵢⱼ, and noeudsParFeuille is the number of service nodes N₀ⱼ connected to a given router N₁ⱼ, called a “leaf” since it belongs to the first level.

Also as an example for XGFT structures, each structural constraint can be chosen from the following inequalities ∀i∈[1,h−1], where h is the number of levels of routers of the interconnection topology:

mᵢ+wᵢ₊₁≦radixMax,

mₕ≦radixMax, and

w₁+noeudsParFeuille≦radixMax.

Also as an example for GFT structures, each structural constraint can be chosen from the following inequalities ∀i∈[1,h−1], where h is the number of levels of routers of the interconnection topology:

m+w≦radixMax,

m≦radixMax, and

w+noeudsParFeuille≦radixMax.

During the second step (20) of the method according to an embodiment of the invention, one determines with a solver (defined by resolution system MR) the optimal interconnection topology of system S, defined by at least one corresponding structural constraint and each topology parameter chosen in the first step (10) and at least one chosen optimisation criterion.

The choice of each optimisation criterion can, for example, be made by the user in first step 10. As a variant, it can be made in second step 20. This choice can be made using the man-machine interface IH, from a list of optimisation criteria supplied by programming interface INP. This list can, for example, be stored in storage system MS of processing device DT.

Due to the definition of the structure of each interconnection topology on the basis of at least one structural constraint defined by at least one variable, it is now possible to determine the optimal interconnection topology of a system S by resolution of an optimisation problem using a solver (or resolution means MR). In other words, the separation between the modelling of the structure and the resolution method enables the search for optimal solutions to be delegated to a reliable and robust mathematical tool (or solver).

As a non-restrictive example, the solver called “Bonmin” may be used, which is capable of resolving systems of non-linear equations with integer variables. It enables accurate solutions to be found in short periods (typically several seconds in the case of topologies of 64,000 service nodes). As a variant, the solver Ipopt may for example be used.

For example, each optimisation criterion can be chosen from among at least the cost of system S, the desired performance level of system S (for example its computational power or its computation speed), the extensibility of system S, the desired energy consumption of system S, thermal constraints, in particular relating to the hosting environment of system S, and the encumbrance of system S (logistical criterion). In general, an optimisation criterion can be any property of an interconnection topology.

It will be noted that in certain situations use solely of structural constraints may lead to a correct interconnection topology, but one which is not usable in practice. Consequently, in second step 20, the optimal interconnection topology can also be determined in terms of at least one chosen usage constraint. For example, each usage constraint may be chosen from among, at least:

a prohibition against connecting to a router Nᵢⱼ (with i>1) belonging to a given level i more links (connections) to the level above this given level than links (or connections) to the level below this given level (indeed, the lower links will not be able to generate sufficient traffic for all the upper links to be used). With the example definitions of variables m, w, p and h given above, this usage constraint may be expressed in a mathematical form using the inequality wᵢ₊₁≦mᵢ,

a conservation of an input and output bandwidth of each router Nᵢⱼ (with i>1). With the example definitions of variables m, w, p and h given above, this usage constraint may be expressed in a mathematical form using the equation facteursMinᵢ=facteursMaxᵢ=1, where facteursMinᵢ and facteursMaxᵢ are minimal and maximal blocking factors for level i in question (where a blocking factor is a ratio of numbers of service nodes between a level above a given level i and a level below this given level i). For example, it is possible to use the inequalities facteursMinᵢ≦pᵢ₊₁*wᵢ₊₁/pᵢ*mᵢ≦facteursMaxᵢ and facteursMin₁≦p₁*w₁/noeudsParFeuille≦facteursMax₁. In this case, if there are only components equal to 1 for facteursMinᵢ and facteursMaxᵢ, then 1≦p₁*w₁/noeudsParFeuille≦1 (for level 1, and the same for the other levels), and therefore the bandwidth is conserved. Conversely, if there are, for example, for level 1 facteursMin₁=0.5 and facteursMax₁=1, up to one ascending link for two descending links is permitted, and therefore there is no conservation of bandwidth. It will be noted that it would be possible to use other formulae in this case, such as, for example, facteursMinᵢ=1 and facteursMaxᵢ=1 for all i or pᵢ₊₁* wᵢ₊₁=pᵢ*mᵢ,

a minimum number of service nodes Nᵢⱼ. With the example definitions of variables m, h and noeudsParFeuille given above, this usage constraint may be expressed in a mathematical form using the inequality noeudsParFeuille [symbol] mᵢ (of i=1 to h)≧minNoeuds, where minNoeuds is the number of service nodes N₀ⱼ connected to leaf routers Nᵢⱼ of the first level (i=1), and

a maximum number of links (connections) between two routers Nᵢⱼ. This usage constraint enables reduced tolerance to malfunctions to be prevented if a router is defective. With the example definition of variable p given above, this usage constraint may be expressed in a mathematical form by means of the inequality 1≦pᵢ≦maxRépétition, where maxRépétition is the maximum number of connections between two routers.

It will be noted that it is also possible to use specific usage constraints to eliminate certain special cases. This is the case, in particular, when one of the components of vector m and/or one of the components of vector w is equal to 1. Indeed, in this case it is possible to construct a similar PGFT structure by deleting one level (for a lower price, and equally resistant to malfunctions). In this case it is possible to use a usage constraint which is expressed in a mathematical form using the inequalities wᵢ₊₁>1 and mᵢ>1.

It will also be noted that the user of electronic device EE can choose, using the man-machine interface IH, each usage constraint from a list of usage constraints supplied by programming interface INP. This list can, for example, be stored in storage system MS of processing device DT.

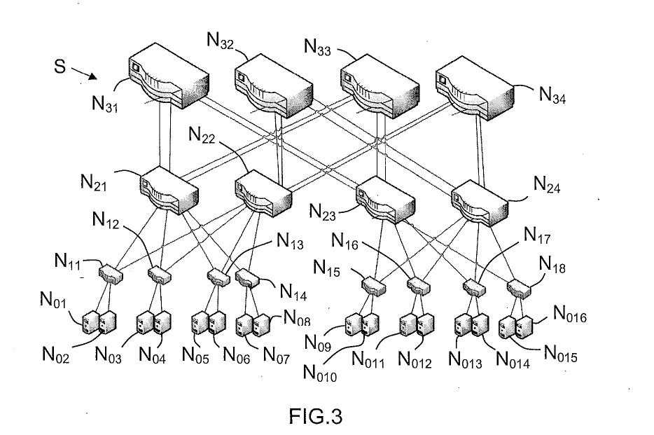

A non-restrictive example of system S with a PGFT structure defined by (h,m,w,p)=(2, [4,2], [2,2], [1,2]) has been illustrated diagrammatically in FIG. 3. It is considered in this case that each router has four available ports. An example construction of this system S is given below.

For the construction of the first level of routers N₁ⱼ, the value of m₁ is used. In this example, m₁ is equal to 4 and therefore routers N₂ⱼ of the second level will be connected to four different leaf routers N₁ⱼ of the first level. After this the value of w₁ is used. In this example, w₁ is equal to 2 and therefore each leaf router N₁ⱼ of the first level is connected to two routers N₂ⱼ of the second level. After this the value of p₁ is used. In this example, p₁ is equal to 1 and therefore a single (non-redundant) link is used between the first and second levels. The term “level 1 island” is given hereinafter to a group containing four routers N₁ⱼ (j=1 to 4) of the first level and two routers N₂ⱼ (j=1 to 2) of the second level. In this example the system contains two level 1 islands.

After this the value of m₂ is used. In this example, m₂ is equal to 2 and therefore routers N₃ⱼ of the third level will be connected to two routers N₂ⱼ of two different level 2 islands. After this the value of w₂ is used. In this example, w₂ is equal to 2 and therefore each router N₂ⱼ of the second level will be connected to two different routers N₃ⱼ belonging to the third level (and more specifically to different level 2 islands). Since each level 1 island has two routers N₂ⱼ of the second level, there are therefore two routers N₃ⱼ in each level 2 island.

After this, the missing connections are completed between the second and third levels, and then, since the value of p₂ is equal to 2, each connection between routers of the second and third levels is duplicated. Finally, in the case of a supercomputer S, compute nodes N₀ⱼ are added, connecting them to routers N₁ⱼ of the first level. In this case, the connection between each compute node N₀ⱼ and corresponding router N₁ⱼ is single, in order that the number of available ports on this router N₁ⱼ is not exceeded.

This construction method may be implemented by the solver (or resolution system MR) for system S of FIG. 3, with all the structural constraints and all the usage constraints described above, but also with the cost of system S as an optimisation criterion.

The invention is not restricted to the embodiments of determination method, processing device, and electronic device described above only as examples, but encompasses all variants which those skilled in the art might envisage solely in the context of the claims hereinafter.

It will be appreciated by one skilled in the art that the disclosed method and system described herein represent a solution to the technological problem currently faced by designers for determining (or dimensioning) the interconnection topology of a system including service nodes such as, for example, a supercomputer.

In the above description, for purposes of explanation, numerous specific details are set forth in order to provide a thorough understanding of the specification. It will be apparent, however, to one skilled in the art that the disclosure can be practiced without these specific details. In other implementations, structures and devices are shown in block diagram form in order to avoid, obscuring the description. For example, the present implementation is described in one implementation primarily with reference to user interfaces and particular hardware. However, the present implementation applies to any type of computing device that can receive data and commands, and any peripheral devices providing services.

Reference in the specification to “one implementation” or “an implementation” or “an embodiment” or “an aspect” means that a particular feature, structure, or characteristic described in connection with the implementation, embodiment or aspect is included in at least one implementation of the description. The appearances of the phrase “in an embodiment” in various places in the specification are not necessarily all referring to the same implementation.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present implementation of the specification also relates to an apparatus for performing the operations herein. This apparatus is specially constructed for the required purposes, or it comprises a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware implementation, an entirely software implementation or an implementation containing both hardware and software elements. In an implementation, the specification is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the specification is not described with reference to any particular programming language. It will be appreciated that a variety of programming languages may be used to implement the teachings of the specification as described herein.

The foregoing description of the implementations of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

1. A method for determining an optimal interconnection topology of a system including service nodes (Nᵢⱼ) interconnected using links some of which are routers with ports, and belonging to at least one level, the method comprising a first step in which a structure is chosen for an optimal interconnection topology to be determined from among a set of structures each defined by at least one structural constraint, and at least one topology parameter is then chosen from among a maximum number of ports of the routers, a number of levels of routers, a number of service nodes (Nᵢⱼ) connected to a router belonging to a first level, a number of service nodes of a level i−1 connected to a given router of a level i, a number of routers of a level i connected to a given service node of a level i−1, a number of links between a router of a level i and a service node (Nᵢ₋₁ⱼ) of a level i−1, and a second step in which, using a solver, the optimal interconnection topology defined by at least one corresponding structural constraint and each chosen topology parameter and at least one chosen optimisation criterion is determined.

2. The method according to claim 1, wherein each optimisation criterion is chosen from a group including a cost of the system, a level of performance of the system, the extensibility of the system, an energy consumption of the system, thermal constraints, and an encumbrance of the system.

3. The method according to claim 1, wherein each structural constraint is chosen from a group of inequalities including pᵢ*mᵢ+pᵢ₊₁*wᵢ₊₁≦radixMax, pₕ*mₕ≦radixMax, and w₁*p₁+noeudsParFeuille≦radixMax, where mᵢ is the number of service nodes of a level i−1 connected to given router of a level i, wᵢ is the number of routers of a level i connected to given service node of a level i−1, pᵢ is the number of links between a router of a level i and a service node (Nᵢ₋₁ⱼ) of a level i−1, radixMax is the maximum number of ports of each router, h is the number of levels of routers, and noeudsParFeuille is the number of service nodes (N₀ⱼ) connected to a given router (N₁ⱼ) belonging to the said first level.

4. The method according to claim 1, wherein in the second step the optimal interconnection topology is also determined in terms of at least one chosen usage constraint.

5. The method according to claim 4, wherein each usage constraint is chosen from a group including a prohibition against connecting to a router belonging to a given level i more links to the level above the given level than links to the level below said given level, conservation of an input and output bandwidth of each router, non-conservation of an input and output bandwidth of each router, a minimum number of service nodes (Nᵢⱼ), and a maximum number of links between two routers.

6. The method according to claim 1, wherein said system is chosen from a group including a supercomputer and a data centre.

7. A non-transitory machine readable medium comprising a computer program product including a set of instructions which, when it is executed by a processing system, is configured to implement a method according to claim 1 to determine an optimal interconnection topology of a system including service nodes (Nᵢⱼ) which are interconnected using links, and some of which are routers with ports, and belonging to at least one level.

8. A processing device for determining an optimal interconnection topology of a system including service nodes (Nᵢⱼ) interconnected using links some of which are routers with ports, and belonging to at least one level, and able to be fitted to an electronic device including computational resources and a man-machine interface, the processing device comprising i) a programming interface configured to enable a user to choose via the man-machine interface a structure for an optimal interconnection topology, to be determined from among a set of structures each one of which is defined by at least one structural constraint, and at least one topology parameter chosen from among a maximum number of router ports, a number of levels of routers, a number of service nodes (Nᵢⱼ) connected to a router belonging to a first level, a number of service nodes of a level i−1 connected to a same router of a level i, a number of routers of a level i connected to the same service node of a level i−1, a number of links between a router of a level i and a service node (Nᵢ₋₁ⱼ) of a level i−1, and ii) a resolution system configured to determine the optimal interconnection topology defined by at least each corresponding structural constraint, and each chosen topology parameter, and by at least one chosen optimisation criterion.

9. An electronic device comprising computational resources, a man-machine interface, and a processing device according to claim 8.
